(19) United States
(12) Patent Application Publication
(10) Pub. No.: US 2022/0016662 A1
(43) Pub. Date: Jan. 20, 2022

(54) COATING APPARATUS AND IMAGE FORMING APPARATUS

(71) Applicant: Konica Minolta, Inc., Tokyo (JP)

(72) Inventor: Katsuhiro UMEDA, Aichi (JP)

(21) Appl. No.: 17/369,126

(22) Filed: Jul. 7, 2021

(30) Foreign Application Priority Data
Jul. 15, 2020 (JP) 2020-121388

(51) Int. Cl. B05C 1/08; B05C 1/14

(52) U.S. Cl. CPC B05C 1/0873; B05C 1/0813; B05C 1/14; B05C 1/0834

(57) ABSTRACT

Provided is a coating apparatus including: a liquid coating section; an adjusting section which is configured to be capable of coming into contact with and/or separating from the liquid coating section, and which adjusts an amount of the liquid in the liquid coating section; and a hardware processor differentiating the contact timing between the coated medium and the liquid coating section and the contact timing between the liquid coating section and the adjusting section in a case where the coated medium is coated with the liquid.

### CROSS REFERENCE TO RELATED APPLICATIONS

The entire disclosure of Japanese Patent Application No. 2020-121388 filed on Jul. 15, 2020 is incorporated herein by reference in its entirety.

### BACKGROUND

### Technological Field

The present invention relates to a coating apparatus and an image forming apparatus.

### Description of Related Art

In an image forming apparatus or the like, printing is performed by attaching ink or the like to a medium; however, when an amount of ink adhering to the medium is reduced from the viewpoint of cost-cutting, the contrast ratio of the ink in the medium decreases. Hence, for example, in a case of printing a solid image, unevenness is caused in an image formed on the medium. In contrast, when spreading of ink on the medium is possible, a decrease in the contrast ratio can be suppressed. However, decreasing ink viscosity to spread the ink allows spreading of the ink on the medium, but also causes bleeding of ink due to uneven penetration.

Thus, a method has been known, which suppresses occurrence of the above problem by coating a medium to be coated (hereinafter, may also be referred to as “coated medium”) with a coat layer (liquid). For example, in a system of printing ink directly on a medium, a pre-coating is performed by coating the medium (coated medium) with the coating layer. A method of expanding a dot diameter while preventing bleeding of dots by the pre-coating has been known.

Moreover, in a method in which ink is attached to an intermediate transfer belt (coated medium), a coating layer that is insoluble in ink and has a high surface tension is formed on the intermediate transfer belt. There has been known a method of improving the transfer rate by making it easier to transfer the ink by the coat layer during transfer to the medium while ensuring wet spreading of the ink when the ink impacts on the surface.

As such an apparatus described above for coating a coated medium with a liquid, for example, Japanese Patent Application Laid-Open No. 2011-194331 discloses a configuration that supplies a liquid to a coating roller via a supply roller so as to coat the coated medium on an impression cylinder with the liquid by the coating roller.

Furthermore, Japanese Patent Application Laid-Open No. 2007-000778 discloses a configuration including a coating roller for coating a coated medium with a liquid and a holding member that comes into contact with the coating roller for the liquid to be held in a liquid holding space of the coating roller.

### SUMMARY

However, at the time of starting up an image forming apparatus, a liquid is not supplied to a liquid coating section which coats the coated medium with the liquid; accordingly, the coated medium (a conveyance member for conveying the coated medium) and the liquid coating section are driven with no liquid. As a result, the liquid coating section and the coated medium (the conveyance member for conveying the coated medium) are likely to be worn out and deteriorated due to the effect of friction, which causes a problem of affecting the image forming and/or of shortening the component life.

An object of the present invention is to provide a coating apparatus and an image forming apparatus capable of suppressing the components associated with the liquid coating section from being worn out and deteriorated due to the effect of friction.

To achieve at least one of the abovementioned objects, according to an aspect of the present invention, a coating apparatus reflecting one aspect of the present invention includes:

a liquid coater configured to be capable of coming into contact with and/or separating from a coated medium which is coated with a liquid, the liquid coater coating the coated medium with the liquid;

an adjuster configured to be capable of coming into contact with and/or separating from the liquid coater, the adjuster adjusting an amount of the liquid in the liquid coater; and

a hardware processor differentiating a contact timing between the coated medium and the liquid coater and a contact timing between the liquid coater and the adjuster in a case where the coated medium is coated with the liquid.

To achieve at least one of the abovementioned objects, according to another aspect of the present invention, an image forming apparatus reflecting one aspect of the present invention includes:

a coating apparatus that coats a coated medium with a liquid; and

an image former that forms an image on the coated medium which is coated with the liquid by the coating apparatus, wherein

the coating apparatus includes:
a liquid coater configured to be capable of coming into contact with and/or separating from the coated medium coated with the liquid, the liquid coater coating the coated medium with the liquid;
an adjuster configured to be capable of coming into contact with and/or separating from the liquid coater, the adjuster adjusting an amount of the liquid in the liquid coater; and
a hardware processor differentiating a contact timing between the coated medium and the liquid coater and a contact timing between the liquid coater and the adjuster in a case where the coated medium is coated with the liquid.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates an entire configuration of an image forming apparatus according to an embodiment of the present invention;

FIG. 2 illustrates main sections of a control system of the image forming apparatus according to the embodiment;

FIG. 3 describes a movement control in a coating section;

FIG. 4 describes the movement control in the coating section;

FIG. 5 describes the movement control in the coating section;

FIG. 6 describes the movement control in the coating section; and

FIG. 7 schematically illustrates an entire configuration of an image forming apparatus according to a modification.

### DETAILED DESCRIPTION OF EMBODIMENTS

Hereinafter, one or more embodiments of the present invention will be described with reference to the drawings. However, the scope of the invention is not limited to the disclosed embodiments.

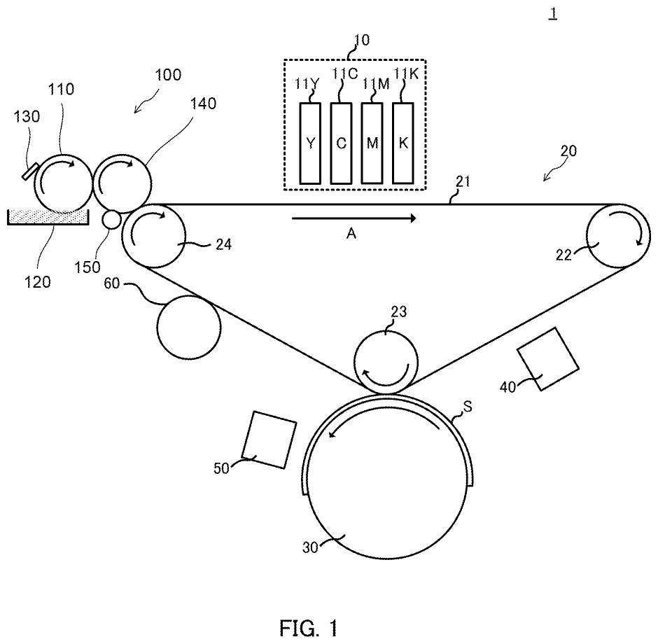

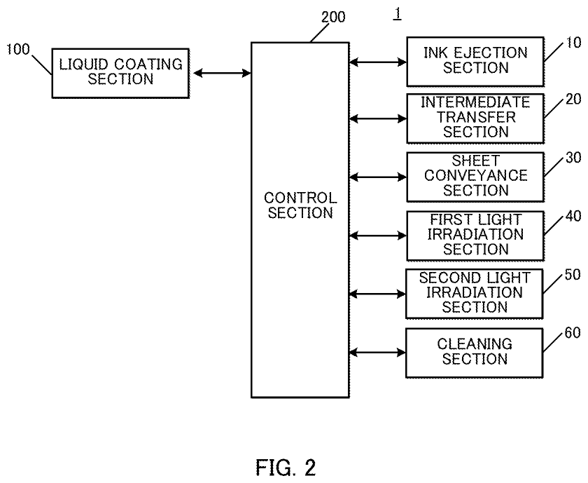

Hereinafter, an embodiment of the present invention will be described in detail with reference to the accompanying drawings. FIG. 1 schematically illustrates an entire configuration of image forming apparatus 1 according to the present embodiment. FIG. 2 illustrates main sections of a control system of image forming apparatus 1 according to the present embodiment.

As illustrated in FIG. 1, image forming apparatus 1 is a color image forming apparatus of an intermediate transfer type using an inkjet system. Image forming apparatus 1 includes ink ejection section 10, intermediate transfer section 20, sheet conveyance section 30, first light irradiation section 40, second light irradiation section 50, cleaning section 60, coating section 100, and control section 200 (see FIG. 2). Coating section 100 corresponds to a “coating apparatus” of the present invention.

As illustrated in FIG. 2, control section 200 includes Central Processing Unit (CPU), Read Only Memory (ROM), Random Access Memory (RAM), and the like. The CPU reads a program corresponding to processing contents from ROM and loads the program into RAM, and controls operation of each block of image forming apparatus 1 in a centralized manner in cooperation with the loaded program. At this time, various kinds of data stored in a storage section (not illustrated) are referred to. The storage section (not illustrated) is configured of, for example, a non-volatile semiconductor memory (so-called flash memory) or a hard disk drive.

As illustrated in FIG. 1, ink ejection section 10 is provided with inkjet heads 11Y, 11C, 11M, and 11K and ejects ink of the respective colors of yellow (Y), magenta (M), cyan (C, and black (K) onto intermediate transfer section 20 so as to form an ink-based image. Note that, inkjet heads 11Y, 11C, 11M, and 11K have the same configuration, and thus, for convenience, Y, M, C, and K will be omitted in the following description. Ink ejection section 10 corresponds to an “image former” of the present invention.

Intermediate transfer section 20 includes intermediate transfer belt 21 as an exemplary coated medium and three support rollers 22, 23, and 24. Intermediate transfer belt 21 is constituted of an endless belt and is suspended in a tensioned state on three support rollers 22, 23, and 24 in an inverted triangle shape. Intermediate transfer belt 21 includes, for example, a surface layer made of a highly chemical resistant material such as a fluororesin, a base layer made of a resin material such as a polyimide, and an elastic layer made of silicon rubber or the like.

At least one of three support rollers 22, 23, and 24 is a drive roller that drives under the control of control section 200. This causes intermediate transfer belt 21 to rotate in a direction of arrow A (i.e., clockwise direction in FIG. 1).

In intermediate transfer belt 21, a part suspended over support rollers 22 and 24 which are positioned at left and right apexes of the inverse triangle shape is an impact surface of the ink ejected from inkjet head 11. In intermediate transfer belt 21, support roller 23 positioned at a lower apex of the inverse triangle shape is a pressure roller that pressurizes intermediate transfer belt 21 toward sheet conveyance section 30 with a predetermined nip pressure.

Sheet conveyance section 30 is constituted of a metallic drum and is pressurized against support roller 23 to form a transfer nip. Sheet conveyance section 30 includes a claw (not illustrated) for fixing ends of recording medium S. Sheet conveyance section 30, under the control of control section 200, fixes the ends of recording medium S to the claw and rotates in the counterclockwise direction in FIG. 1, thereby conveys recording medium S to the transfer nip.

First light irradiation section 40 faces the impact surface of the ink of intermediate transfer belt 21 on a downstream side of ink ejection section 10. First light irradiation section 40 irradiates an image formed on intermediate transfer belt 21 with Ultra Violet (UV) light to pre-harden the image.

Second light irradiation section 50 faces a downstream side part of the transfer nip in sheet conveyance section 30 and irradiates an image on recording medium S with UV light to harden the image.

The image formed on the surface of intermediate transfer belt 21 by inkjet head 11 is pre-hardened by first light irradiation section 40 due to intermediate transfer belt 21 being rotated and is conveyed to the transfer nip of support roller 23 and sheet conveyance section 30. The image conveyed to the transfer nip is then transferred to recording medium S to be conveyed by sheet conveyance section 30. The image transferred to recording medium S is hardened by second light irradiation section 50.

Cleaning section 60 is positioned on a downstream side of the transfer nip and, under the control of control section 200, removes a remaining transfer image or the like which is an image formed on intermediate transfer belt 21.

Coating section 100 is a portion for coating intermediate transfer belt 21 with a liquid and includes anilox roller 110, liquid reservoir 120, blade 130, coating roller 140, and cleaning member 150

The liquid, for example, includes a component insoluble in ink and having a relatively high surface tension. Note that, the liquid is not limited to the above and can be appropriately changed according to the use of the liquid.

Anilox roller 110 is made of, for example, a metallic material and is a rotatable roller member for adjusting (weighing) an amount of the liquid in coating roller 140. Anilox roller 110 corresponds to an “adjuster” of the present invention.

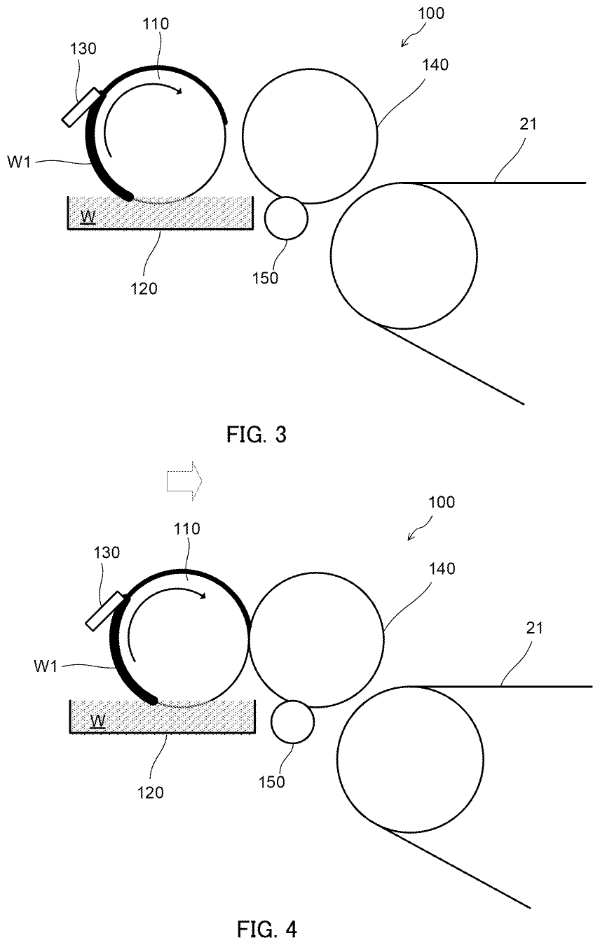

As illustrated in FIGS. 3 and 4, anilox roller 110 is capable of holding liquid W1 and is configured so as to be brought into contact with/separated from coating roller 140 by a publicly known movement mechanism (not illustrated).

Liquid reservoir 120 is a portion for storing liquid W to be supplied to anilox roller 110 and is configured to be movable relative to anilox roller 110 by a publicly known movement mechanism (not illustrated). In a case where liquid reservoir 120 is placed at a position in which anilox roller 110 is soaked in liquid reservoir 120, anilox roller 110 is supplied with liquid W of liquid reservoir 120.

Anilox roller 110 holds liquid W1 by being soaking in liquid reservoir 120 and rotates to convey held liquid W1 to a position corresponding to a contact part with respect to coating roller 140. When liquid W1 moves to the position corresponding to the contact part, anilox roller 110 moves to a position in contact with coating roller 140 under the control of control section 200. Thus, liquid W1 is supplied from anilox roller 110 to coating roller 140.

Blade 130 is a member that makes an amount of liquid W1 held by anilox roller 110 in liquid reservoir 120 constant. Blade 130 comes into contact with anilox roller 110 at a downstream side of liquid reservoir 120 in a rotational direction of anilox roller 110 and on an upstream side of coating roller 140 so as to scrape off liquid W1 held on a surface of anilox roller 110. Blade 130 makes a thickness of liquid W1 on a downstream side of blade 130 thinner than that of liquid W1 on an upstream side of blade 130.

Coating roller 140 is constituted of, for example, an elastic member such as rubber and is a rotatable roller member for coating intermediate transfer belt 21 with a liquid. Coating roller 140 corresponds to a “liquid coater” of the present invention.

Coating roller 140 is capable of holding liquid W2 and is configured so as to be capable of coming into contact with and/or separating from intermediate transfer belt 21 by a publicly known movement mechanism (not illustrated).

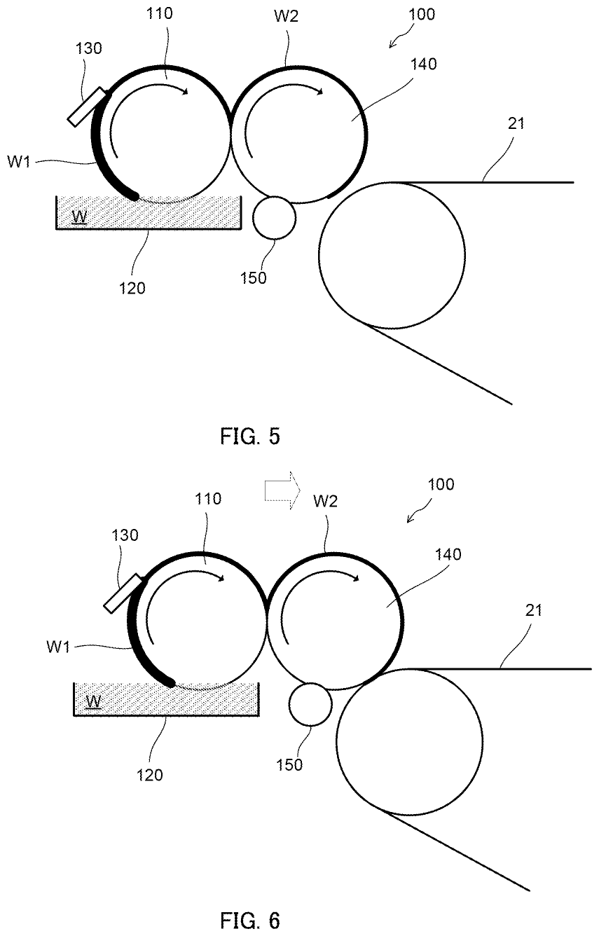

As illustrated in FIG. 5 and FIG. 6, coating roller 140 holds liquid W2 at a contact part with respect to anilox roller 110 and rotates to convey held liquid W2 to a position corresponding to a contact part with respect to intermediate transfer belt 21. When liquid W2 moves to the position corresponding to the contact part, coating roller 140 moves to a position contacting intermediate transfer belt 21 under the control of control section 200. Thus, intermediate transfer belt 21 is coated with liquid W2 held by coating roller 140.

Cleaning member 150 is, for example, a brush and comes into contact with coating roller 140 and cleans liquid W2 held by coating roller 140, at a downstream side of the contact part of coating roller 140 with respect to intermediate transfer belt 21 in a rotational direction of coating roller 140.

As described above, cleaning member 150 enables removing liquid W2 remaining on coating roller 140 without coating intermediate transfer belt 21. Consequently, it is possible to suppress remaining liquid W2 from evaporating on coating roller 140

Control section 200 controls coating with a liquid in coating section 100 by, for example, controlling the movement of anilox roller 110 and coating roller 140 at the start-up of image forming apparatus 1. The start-up of image forming apparatus 1 indicates, for example, the timing of turning on the power supply of image forming apparatus 1 or the timing of starting driving of image forming apparatus 1.

Specifically, when coating intermediate transfer belt 21 with a liquid, control section 200 brings anilox roller 110 and coating roller 140 into contact with each other and brings coating roller 140 and intermediate transfer belt 21 into contact with each other as well from a state where anilox roller 110, coating roller 140 and intermediate transfer belt 21 are separated from one another. In this case, control section 200 differentiates the contact timing between intermediate transfer belt 21 and coating roller 140 and the contact timing between coating roller 140 and anilox roller 110 from each other.

Control section 200 brings coating roller 140 and anilox roller 110 into contact with each other before bringing intermediate transfer belt 21 and coating roller 140 into contact with each other.

In particular, firstly, as illustrated in FIG. 3, anilox roller 110 rotationally drives to convey liquid W to the position corresponding to the contact part with respect to coating roller 140 while holding liquid Win liquid reservoir 120 from a state where anilox roller 110, coating roller 140 and intermediate transfer belt 21 are separated from one another.

As illustrated in FIG. 4, control section 200 brings anilox roller 110 into contact with coating roller 140.

Next, as illustrated in FIG. 5, coating roller 140, while holding the liquid supplied from anilox roller 110, rotationally drives to convey the liquid to the position corresponding to the contact part with respect to intermediate transfer belt 21.

As illustrated in FIG. 6, control section 200 brings coating roller 140 into contact with intermediate transfer belt 21.

For example, in an apparatus in which a coating roller and an intermediate transfer belt are always in contact with each other, no liquid is supplied to the coating roller when, for example, the apparatus starts up; thus, the intermediate transfer belt and the coating roller are driven with no liquid. As a result, the coating roller and the intermediate transfer belt are likely to be worn out and deteriorated due to effect of friction, which causes a problem of affecting the image forming and/or of shortening the component life.

In contrast, in the present embodiment, the liquid is supplied from anilox roller 110 to coating roller 140 at the timing before coating roller 140 is brought into contact with intermediate transfer belt 21. Thus, when coating roller 140 is brought into contact with intermediate transfer belt 21, the liquid is easily interposed in the contact part between coating roller 140 and intermediate transfer belt 21.

Consequently, it is possible to suppress coating roller 140 and intermediate transfer belt 21 from being worn out and deteriorated due to the effect of friction, and thus, it is possible to suppress the image forming in image forming apparatus 1 from being affected and/or suppress the component life from being shortened.

Further, as illustrated in FIGS. 3 and 4, control section 200 brings coating roller 140 and anilox roller 110 into contact with each other with liquid W1 interposed in the contact part of anilox roller 110 with coating roller 140.

Specifically, control section 200 brings coating roller 140 and anilox roller 110 into contact with each other at or after the timing when a part of anilox roller 110 that has initially held liquid W1 reaches the contact part with respect to coating roller 140.

The part that has initially held the liquid is the part where the supply of the liquid is started in anilox roller 110 or coating roller 140 in a state of holding no liquid.

In the manner described above, when coating roller 140 and anilox roller 110 are brought into contact with each other, liquid W1 is reliably interposed in the contact part of anilox roller 110 with coating roller 140.

Consequently, it is possible to prevent anilox roller 110 and coating roller 140 from rotationally driving in contact with each other with no liquid W1 in the contact part, which enables suppressing coating roller 140 and anilox roller 110 from being worn out and deteriorated due to the effect of friction.

Further, as illustrated in FIGS. 5 and 6, control section 200 brings intermediate transfer belt 21 and coating roller 140 into contact with each other with liquid W2 interposed in the contact part of coating roller 140 with intermediate transfer belt 21.

Specifically, control section 200 brings intermediate transfer belt 21 and coating roller 140 into contact with each other after the timing when a part of coating roller 140 that has initially held liquid W2 reaches the contact part with respect to intermediate transfer belt 21.

In the manner described above, when intermediate transfer belt 21 and coating roller 140 are brought into contact with each other, liquid W2 is reliably interposed in the contact part of coating roller 140 with intermediate transfer belt 21.

Consequently, it is possible to prevent coating roller 140 and intermediate transfer belt 21 from rotationally driving in contact with each other with no liquid W2 in the contact part, which enables suppressing intermediate transfer belt 21 and coating roller 140 from being worn out and deteriorated due to the effect of friction.

Further, intermediate transfer belt 21 and coating roller 140 are brought into contact with each other at the timing when the part of coating roller 140 that has initially held liquid W2 reaches the contact part with respect to intermediate transfer belt 21, and thus, it is possible to suppress the part of coating roller 140 that has initially held liquid W2 from passing through the contact part with respect to intermediate transfer belt 21.

For example, in a case where a coating roller is brought into contact with an intermediate transfer belt at any timing after the coating roller sufficiently holds a liquid, the liquid is supplied from an anilox roller to the coating roller with the coating roller holding the liquid. That is, an excessive liquid is continuously supplied to the coating roller.

Hence, until the intermediate transfer belt is coated with the liquid, a part of the liquid on the coating roller evaporates, and the liquid is further supplied to the part where the liquid has evaporated. Consequently, concentration of the liquid in the part increases, which may result in a situation where the intermediate transfer belt is abnormally coated due to the intermediate transfer belt being coated with the liquid by the part.

In contrast, in the present embodiment, intermediate transfer belt 21 is coated with liquid W2 of the part of coating roller 140 that has initially held liquid W2, without the part passing through the contact part with respect to intermediate transfer belt 21. Thus, the liquid on coating roller 140 is reduced to some extent.

Thus, even when liquid W1 is supplied again from anilox roller 110 to the part where the liquid in coating roller 140 is reduced, the amount of the liquid in the part does not become excessive.

That is, coating roller 140 can be prevented from being excessively supplied with the liquid. As a result, it is possible to prevent an increase in concentration of the liquid on coating roller 140 and thus to suppress the situation where intermediate transfer belt 21 is coated abnormally.

According to the present embodiment configured as described above, by differentiating the contact timing of the components, it is possible to suppress anilox roller 110, coating roller 140 and intermediate transfer belt 21 at the start of driving in coating section 100 from being worn out and deteriorated.

Thus, it is possible to suppress the image forming in image forming apparatus 1 from being affected and/or suppress the component life from being shortened.

Further, since each of the components is brought into contact in a state where the liquid is interposed in the contact part of the component, it is possible to reliably prevent each of the components from being worn out and deteriorated caused by friction due to the absence of the liquid.

Further, intermediate transfer belt 21 is brought into contact with coating roller 140 at the timing when the part of coating roller 140 that has initially held the liquid reaches the contact part with respect to intermediate transfer belt 21.

Consequently, intermediate transfer belt 21 is coated with the liquid of the part of coating roller 140 that has initially held without the part passing through the contact part with respect to intermediate transfer belt 21. Thus, coating roller 140 can be prevented from being excessively supplied with a liquid.

That is, in the present embodiment, it is possible to suppress the wear out and deterioration of each of the components due to friction at the start of driving of coating section 100 and to suppress the evaporation of the liquid in coating roller 140. As a result, the ink from ink ejection section 10 can be spread in an appropriate size on intermediate transfer belt 21; thus, image quality can be improved.

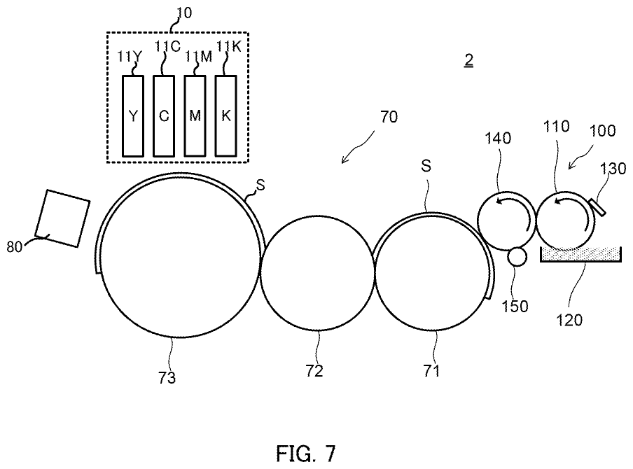

Note that, in the above embodiment, image forming apparatus 1 of an intermediate transfer type has been described as an example; however, the present invention is not limited to this, and for example, image forming apparatus 2 of a direct transfer type as illustrated in FIG. 7 is possible.

Image forming apparatus 2 includes ink ejection section 10, sheet conveyance section 70, light irradiation section 80, coating section 100, and control section 200. Ink ejection section 10 and control section 200 are substantially similar to image forming apparatus 1 illustrated in FIG. 1.

Sheet conveyance section 70 includes first conveyance member 71, second conveyance member 72 and third conveyance member 73 which are made of metallic drums. First conveyance member 71 is in contact with second conveyance member 72 and conveys recording medium S to a contact part with respect to second conveyance member 72. Recording medium S conveyed to the contact part between first conveyance member 71 and second conveyance member 72 is transferred from first conveyance member 71 to second conveyance member 72 at the contact part.

Second conveyance member 72 is in contact with first conveyance member 71 and third conveyance member 73 and conveys recording medium S transferred from first conveyance member 71 to the contact part with respect to third conveyance member 73. Recording medium S conveyed to the contact part between second conveyance member 72 and third conveyance member 73 is transferred from second conveyance member 72 to third conveyance member 73 at the contact part.

Third conveyance member 73 is in contact with second conveyance member 72 and conveys recording medium S transferred from second conveyance member 72. Besides, ink ejection section 10 faces third conveyance member 73 and ejects ink onto recording medium S conveyed by third conveyance member 73 so as to form an ink-based image.

Light irradiation section 80 faces an impact surface of the ink of third conveyance member 73 on a downstream side of ink ejection section 10. Light irradiation section 80 irradiates an image formed on recording medium S with UV light to harden the image.

Coating section 100 is a portion for coating recording medium S (coated medium) with a liquid and is placed at a position corresponding to first conveyance member 71 Coating section 100 includes, similar to the configuration illustrated in FIG. 1, anilox roller 110, liquid reservoir 120, blade 130, coating roller 140, and cleaning member 150.

Coating roller 140 in this configuration coats recording medium S with a liquid. More specifically, coating roller 140 in this configuration is configured so as to be capable of coming into contact with and/or separating from first conveyance member 71 (recording medium S conveyed by first conveyance member 71), and comes into contact with recording medium S to coat recording medium S with the liquid. The control related to the contact timings of anilox roller 110, coating roller 140, and recording medium S (coated medium) are the same as those of the configuration illustrated in FIG. 1.

In such a configuration, by differentiating the contact timing of each of the components, it is possible to suppress anilox roller 110, coating roller 140 and first conveyance member 71 that conveys recording medium S (a component related to coating roller 140) at the start of driving in coating section 100 from being worn out and deteriorated.

Thus, it is possible to suppress the image forming in image forming apparatus 2 from being affected and/or suppress the component life from being shortened.

In addition, in the above embodiment, cleaning member 150 is always in contact with coating roller 140; however, the present invention is not limited to this. For example, cleaning member 150 may be configured so as to be capable of coming into contact with and/or separating from coating roller 140.

In this case, cleaning member 150 is movably configured by a publicly known movement mechanism. Control section 200 brings cleaning member 150 into contact with coating roller 140 at a position of coating roller 140 corresponding to a contact part with respect to cleaning member 150 at the timing when the liquid reaches.

In the manner described above, the time during which coating roller 140 and cleaning member 150 are in contact with each other in absence of the liquid can be reduced; thus, it is possible to suppress coating roller 140 and cleaning member 150 from being worn out.

Further, in the above embodiment, cleaning member 150 is provided; however, the present invention is not limited to this. A cleaning member may not be provided.

Further, in the above embodiment, liquid reservoir 120 is configured to be movable relative to anilox roller 110; however, the present invention is not limited to this. The liquid storage section may be configured not to move relative to an anilox roller.

Further, above embodiment, the liquid is supplied to anilox roller 110 by liquid reservoir 120; however, the present invention is not limited to this. A liquid may be supplied to an anilox roller by another supply member.

Further, in the above embodiment, anilox roller 110 is exemplified as an adjusting section; however, the present invention is not limited to this. The adjusting section may be a member such as a blade capable of adjusting an amount of a liquid of a liquid coating section (coating roller).

Further, in the above embodiment, intermediate transfer belt 21 and coating roller 140 are brought into contact with each other at the timing when the part of coating roller 140 that has initially held liquid W2 reaches the contact part with respect to intermediate transfer belt 21; however, the present invention is not limited to this. For example, a control section may bring a coated medium into contact with a coating roller at or after a timing when a part of the coating roller that has initially held a liquid reaches a contact part with respect to the coated medium.

In this configuration, since the liquid may pass through the contact part between the coated medium and the coating roller, the above-described cleaning member is preferably provided from the viewpoint of preventing evaporation of the liquid on the coating roller. Moreover, from the viewpoint of preventing the effect of friction between the coating roller and the cleaning member, the above-described cleaning member is further preferably configured so as to be capable of coming into contact with and/or separating from the coating roller.

Further, in the embodiments described above, the liquid coating section (coating apparatus) is provided in the image forming apparatus; however, the present invention is not limited to this. The liquid coating section may be provided in an apparatus other than an image forming apparatus as long as the apparatus is capable of mounting the liquid coating section.

Further, in the embodiments described above, the coating roller and the coated medium, as well as the anilox roller and the coating roller, are brought into contact with each other at the time of starting-up the image forming apparatus; however, the present invention is not limited to this. For example, the coating roller and the coated medium, as well as the anilox roller and the coating roller, may be brought into contact with each other at an appropriate timing such as the timing of starting a print job.

The embodiments described above are merely examples of specific implementation of the present invention, and the technical scope of the present invention should not be restrictively interpreted by these embodiments. That is, the present invention may be implemented in various forms without departing from the spirit thereof or the major features thereof

Although embodiments of the present invention have been described and illustrated in detail, the disclosed embodiments are made for purposes of illustration and example only and not limitation. The scope of the present invention should be interpreted by terms of the appended claims.

What is claimed is:

1. A coating apparatus, comprising:
a liquid coater configured to be capable of coming into contact with and/or separating from a coated medium which is coated with a liquid, the liquid coater coating the coated medium with the liquid;
an adjuster configured to be capable of coming into contact with and/or separating from the liquid coater, the adjuster adjusting an amount of the liquid in the liquid coater; and
a hardware processor differentiating a contact timing between the coated medium and the liquid coater and a contact timing between the liquid coater and the adjuster in a case where the coated medium is coated with the liquid.

2. The coating apparatus according to claim 1, wherein
the hardware processor brings the liquid coater and the adjuster into contact with each other before bringing the coated medium and the liquid coater into contact with each other.

3. The coating apparatus according to claim 1, wherein
the hardware processor brings the liquid coater and the adjuster into contact with each other with the liquid interposed in a contact part of the adjuster with respect to the liquid coater.

4. The coating apparatus according to claim 3, wherein
the adjuster includes a roller member capable of holding the liquid and that rotates to convey the liquid which is held to the contact part with respect to the liquid coater.

5. The coating apparatus according to claim 4, wherein
the hardware processor brings the liquid coater and the adjuster into contact with each other at or after a timing when a part of the adjuster that has initially held the liquid reaches the contact part with respect to the liquid coater.

6. The coating apparatus according to claim 4, further comprising:
a supplier for supplying the roller in the adjuster with the liquid.

7. The coating apparatus according to claim 1, wherein
the hardware processor brings the coated medium and the liquid coater into contact with each other with the liquid interposed in a contact part of the liquid coater with respect to the coated medium.

8. The coating apparatus according to claim 7, wherein
the liquid coater includes a roller member capable of holding the liquid and that rotates to convey the liquid which is held to the contact part with respect to the coated medium.

9. The coating apparatus according to claim 8, wherein
the hardware processor brings the coated medium and the liquid coater into contact with each other at a timing when a part of the liquid coater that has initially held the liquid reaches the contact part with respect to the coated medium.

10. The coating apparatus according to claim 1, further comprising:
a cleaner that comes into contact with the liquid coater and cleans the liquid at a downstream side of a contact part with respect to the coated medium in a rotation direction of the liquid coater, the liquid being held by the liquid coater, wherein
the cleaner is configured to be capable of coming into contact with and/or separating from the liquid coater, and
the hardware processor brings the cleaner into contact with the liquid coater at a timing when the liquid held by the liquid coater reaches a contact part with respect to the liquid coater.

11. The coating apparatus according to claim 10, wherein
the hardware processor brings the coated medium and the liquid coater into contact with each other at or after a timing when a part of the liquid coater that has initially held the liquid reaches the contact part with respect to the coated medium.

12. An image forming apparatus, comprising:
a coating apparatus that coats a coated medium with a liquid; and
an image former that forms an image on the coated medium which is coated with the liquid by the coating apparatus, wherein
the coating apparatus includes:
a liquid coater configured to be capable of coming into contact with and/or separating from the coated medium coated with the liquid, the liquid coater coating the coated medium with the liquid;
an adjuster configured to be capable of coming into contact with and/or separating from the liquid coater, the adjuster adjusting an amount of the liquid in the liquid coater; and
a hardware processor differentiating a contact timing between the coated medium and the liquid coater and a contact timing between the liquid coater and the adjuster in a case where the coated medium is coated with the liquid.

13. The image forming apparatus according to claim 12, wherein
in a case of starting-up the image forming apparatus, the hardware processor brings the adjuster and the liquid coater into contact with each other and brings the liquid coater and the coated medium into contact with each other.
